(19) United States
(12) Patent Application Publication
(10) Pub. No.: US 2026/0154128 A1
(43) Pub. Date: Jun. 4, 2026

(54) METHOD AND SYSTEM FOR PROVIDING A BANDWIDTH (BW) VOTE TO BUS CONTROL CIRCUITRY COUPLED TO ONE OR MORE SUBSYSTEMS PRESENT ON A SYSTEM-ON-CHIP (SOC)

(71) Applicant: Qualcomm Incorporated, San Diego, CA (US)

(72) Inventors: Amir VAJID, San Diego, CA (US); David Young-Suk AHN, San Diego, CA (US); Sumit GEMINI, Delhi (IN); Nikhil Kumar KANSAL, San Diego, CA (US); Shivnandan KUMAR, Hyderabad (IN)

(21) Appl. No.: 18/964,363

(22) Filed: Nov. 30, 2024

(51) Int. Cl. G06F 9/52; G06F 9/30; G06F 15/76; G06F 15/78

(52) U.S. Cl. CPC G06F 9/524; G06F 9/30047; G06F 15/7885; G06F 2015/765

(57) ABSTRACT

Systems and methods are provided for using subsystem metrics to dynamically adjust the bandwidth (BW) scaling factor used when voting for BW needs based on the BW of monitored traffic. For a CPU core, for example, it can be inefficient to use a static BW scaling factor when other core metrics provide extra information that can improve power consumption efficiency without degrading performance or user experience. Dynamically adjusting or selecting the BW scaling factor based on metrics is more efficient than using a static scaling factor and can result in greater efficiency in terms of achieving lower power consumption without degrading performance or user experience.

### DESCRIPTION OF THE RELATED ART

A computing device may include multiple processor-based subsystems. Such a computing device may be, for example, a portable computing device (“PCD”), such as a laptop or palmtop computer, a cellular telephone or smartphone, a portable digital assistant, a portable game console, etc. Still other types of PCDs may be included in automotive and Internet-of-Things (“IoT”) applications. A computing device may also be a stationary computer, such as a personal computer (PC) or various types of desktop computers or workstation computers.

Such processor-based subsystems may be included within the same integrated circuit chip or in different chips. A “system-on-a-chip”, or “SoC”, is an example of one such chip that integrates numerous subsystems to provide system-level functionality. For example, an SoC may include one or more types of processors, such as central processing units (“CPU” ), graphics processing units (“GPU” ), digital signal processors (“DSP” ), and neural processing units (“NPU” ). An SoC may include other subsystems, such as a transceiver or “modem” subsystem that provides wireless connectivity, a memory subsystem, etc.

Some of the subsystems of the SoC are interconnected by a common bus whereas others are interconnected by particular interconnects. The buses and interconnects are clocked at particular clock rates to ensure that data being transmitted and received between the subsystems meets bandwidth (BW) requirements and timing constraints. BW monitoring hardware (HW) blocks monitor the traffic on the buses and other interconnects to measure the BW of the traffic on them and then the various subsystems vote on BW allocation among the various interconnections based on their actual usage.

Current BW monitoring and voting design has a static BW scaling factor for which BW measured at hardware (HW) monitoring blocks is translated into BW voted on for the relevant bus/interconnects. For example, a 2× scaling factor would mean voting 10 GB/s for BW needs when measuring 5 GB/s of traffic. This scaling factor is typically needed to either (1) give traffic room to grow or (2) cover a core's memory latency needs (i.e., the need to vote higher on bus/clocks to improve memory access latency). Thus, this scaling factor is needed to meet performance needs.

### SUMMARY OF THE DISCLOSURE

Systems, methods, computer program products, and other examples are disclosed for utilizing metrics associated with a subsystem of a system-on-a-chip (SoC) to select a bandwidth (BW) scaling factor that will be used to select a clock frequency of a bus or interconnect.

A bandwidth (BW) voting logic coupled to one or more subsystems comprises a module. The module may be configured to determine a BW usage of a communication bus coupled to the one or more subsystem. The module may be configured to determine a BW scaling factor based on one or more metrics of the one or more subsystems. The module may also be configured to vote for a BW based on BW usage of the communication bus and the BW scaling factor.

A method for providing a bandwidth (BW) vote to bus control circuitry includes determining a BW usage of a communication bus coupled to one or more subsystems. The method may further include determining a BW scaling factor based on one or more metrics of the one or more subsystems. The method may also include providing a vote for BW based on BW usage of the communication bus and the BW scaling factor.

A computer program product comprises a non-transitory computer usable medium having a computer readable program code embodied therein and the computer readable program code is adapted to be executed to implement a method for providing a bandwidth (BW) vote to bus control circuitry. The code implementing the method may include determining a BW usage of a communication bus coupled to one or more subsystems.

The code implementing the method may further include determining a BW scaling factor based on one or more metrics of the one or more subsystems. The code implementing the method may also include providing a vote for BW based on BW usage of the communication bus and the BW scaling factor.

These and other features and advantages will become apparent from the following description, drawings and claims.

### BRIEF DESCRIPTION OF THE DRAWINGS

In the Figures, like reference numerals refer to like parts throughout the various views unless otherwise indicated.

FIG. 1 illustrates a block diagram of a system in accordance with a representative embodiment for dynamically adjusting the BW scaling factor based on subsystem metrics.

FIG. 2 is a block diagram of the BW scaling module of FIG. 1 that is used to dynamically adjust or select the BW scaling factor based on (1) an indication of the BW measured by a BW monitoring circuit and on (2) one or more metrics related to the subsystem for which the BW was measured.

FIG. 3 illustrates a state diagram representing operations of a state machine that can be used to implement the inventive principles and concepts in accordance with an exemplary embodiment in which the state machine switches scaling factor states based at least in part on metrics that indicate whether the subsystem is in a high-performance, mid-performance or low-performance state.

FIG. 4 illustrates a flow diagram representing the method of the present disclosure in accordance with an embodiment.

FIG. 5A illustrates a flow diagram representing the processing step / routine 404 shown in FIG. 4 in accordance with an exemplary embodiment in which the metric is the operating frequency of a core of a multi-core CPU.

FIG. 5B, illustrates a flow diagram representing a method of the present disclosure in accordance with an alternative exemplary embodiment compared to the flow diagram of FIG. 4 and logic divisions of FIG. 2.

FIG. 6 illustrates an example of a portable computing device (PCD) in which exemplary embodiments of systems, methods, computer-readable media, and other examples of the inventive principles and concepts of the present disclosure may be implemented.

### DETAILED DESCRIPTION

The present disclosure discloses systems and methods for using subsystem metrics to dynamically adjust the bandwidth (BW) scaling factor used when voting for BW needs based on the BW of monitored traffic. For a CPU core, for example, it can be inefficient to use a static BW scaling factor when other core metrics provide extra information that can improve power consumption efficiency without degrading performance or user experience. For example, if core frequency is very low, it is likely more efficient to have a smaller scaling factor, whereas when core frequency is high, it is likely better from a performance or user experience perspective to use a larger scaling factor.

As indicated above, current BW monitoring and voting configurations and processes use a static BW scaling factor for which BW measured at BW monitoring blocks is translated into BW voted on by the subsystems for the relevant bus/clocks.

For example, a 2× scaling factor would mean voting 10 GB/s for BW needs when measuring 5 GB/s. However, for a core such as a CPU core, for example, it can be inefficient to have a static factor when other core metrics give extra information that can improve efficiency. For example, if core frequency is very low it is likely more efficient to have a smaller scaling factor whereas when core frequency is high, having a larger scaling factor is likely better.

When determining the vote required to satisfy CPU workload requirements, the amount of BW voted for can be miscorrelated to real requirements. Utilizing certain metrics to detect these needs more accurately can improve power usage without impacting performance, which results in an overall improvement in efficiency. The following provides a discussion of exemplary embodiments for utilizing subsystem metrics to dynamically adjust the BW scaling factor.

In the following detailed description, for purposes of explanation and not limitation, exemplary, or representative, embodiments disclosing specific details are set forth in order to provide a thorough understanding of an embodiment according to the present teachings.

The word “exemplary” is used herein to mean “serving as an example, instance, or illustration.” The words “illustrative” or “representative” may be used herein synonymously with “exemplary.” Any aspect described herein as “exemplary” is not necessarily to be construed as preferred or advantageous over other aspects. However, it will be apparent to one having ordinary skill in the art and having the benefit of the present disclosure that other embodiments according to the present teachings that depart from the specific details disclosed herein remain within the scope of the appended claims.

Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements'relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory device”, as that term is used herein, is intended to denote a non-transitory computer-readable storage medium that is capable of storing computer instructions, or computer code, for execution by one or more processors. References herein to a “memory device” should be interpreted as including one or more memory devices.

A “processor”, as that term is used herein, encompasses an electronic component that carries out tasks in hardware, software, and/or firmware. For example, a processor can be an electronic component that is programmed to execute a computer program or executable computer instructions.

A processor can also be an electronic component comprising one or more state machines. A processor may be a multi-core processor comprising multiple processing cores, each of which may comprise multiple processing stages of a processing pipeline. A processor may also refer to a collection of processors within a single system or distributed amongst multiple systems.

A “controller”, as that term is used herein, can mean, for example, a processor, such as a multi-core microprocessor, or a microcontroller.

The term “logic”, as that term is used herein, means circuitry that is programmed or configured by software and/or firmware to perform particular operations. For example, logic gates of logic arrays, state machines or processors are examples of “logic”, as that term is used herein. The term “circuit”, as that term is used herein, denotes electrical circuitry comprising analog and/or discrete circuit elements or components.

A computing device may include multiple subsystems, cores or other components. Such a computing device may be, for example, a portable computing device (PCD), such as a laptop or palmtop computer, a cellular telephone or smartphone, a portable digital assistant, a portable game console, an automotive safety system, etc., or a non-portable computing device (NPCD) such as, for example, a PC, a desktop or a workstation computer.

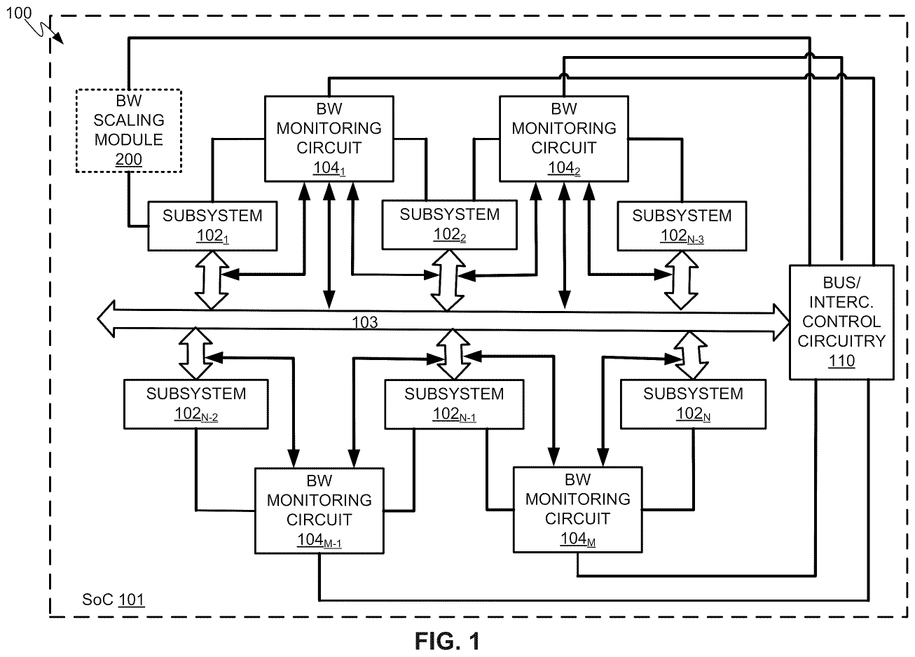

FIG. 1 illustrates a block diagram of a system 100 in accordance with a representative embodiment for dynamically adjusting the bandwidth (BW) scaling factor based on subsystem metrics. An SoC 101 of the system 100 comprises a plurality of subsystems 102₁-102_{N}, a communication bus 10 and/or other interconnects 103 for interconnecting the subsystems 102₁-102_{N}. The SoC 101 may also include a plurality of BW monitoring circuits 104₁-104_{M} for monitoring BW usage (i.e., traffic) of the bus and/or other interconnects 103.

The SoC 101 may further include bus/interconnect control circuitry 110 for controlling the clock frequency/rate(s) and other operations of the communication bus/interconnects 103. The letters “M” and “N” of FIG. 1 are positive integers that may or may not be equal to one another.

The thick arrows 103 of FIG. 1 represent one or more buses that are used by one or more of the subsystems 102₁-102_{N} as well as other types of interconnects that extend in between particular subsystems 102₁-102_{N}, such as, for example, interconnects that extend in between a CPU and cache memory or in between a network-on-a-chip (NOC) and a memory controller of a memory management unit (MMU).

The subsystems 102₁-102_{N} can be any type of subsystem that can be found on an SoC 101, such as, for example, a CPU, an NOC, a graphics processing unit (GPU), main memory, cache memory, a memory management unit (MMU), a digital signal processor (DSP), and a neural processing unit (NPU), etc.

The BW monitoring circuits 104₁-104_{M} can be at various locations throughout the SoC 101 for monitoring traffic on various buses or interconnects and can have different configurations depending on the types of buses/interconnects they are used to monitor. The BW monitoring circuits 104₁-104_{M} are shown in FIG. 1 as being external to the subsystems 102₁-102_{N}, but they can also be internal to one or more of the subsystems 102₁-102_{N}.

The bus/interconnect control circuitry 110 can be in communication with the BW monitoring circuits 104₁-104_{M} and with the communication bus/interconnects 103. The subsystems 102₁-102_{N} can also be in communication with the BW monitoring circuits 104₁-104_{M}.

While a single instance of the bus/interconnect control circuitry 110 is shown in FIG. 1, there can be multiple instances of the bus/interconnect control circuitry 110 distributed across the SoC 101 and they may or may not have the same configurations. For example, there may be different types of bus/interconnect control circuits for different types of buses of interconnects and they may have configurations that vary in accordance with the configuration of the bus or interconnect they control.

The BW monitoring circuits 104₁-104_{M} monitor the BW of traffic on the buses/interconnects 103 and provide this information to the bus/interconnect control circuitry 110 and to the relevant subsystems 102₁-102_{N}. Based on this information and based on one or more metrics associated with the subsystem 102₁-102_{N}, the subsystems 102₁-102_{N} or the bus/interconnect control circuitry 110 decide on the BW scaling factor to be used.

The logic for making this BW scaling factor determination may be located at any suitable location. In accordance with an exemplary embodiment, the logic may comprise software running on a CPU which is illustrated in FIG. 1 as the BW scaling module 200. The BW scaling module 200 is illustrated as a functional block highlighted with dashed lines and it is shown coupled to the bus/interconnect control circuitry 110. In the alternative to software running on a CPU, the BW scaling module 200 may be embodied as (may comprise) specific hardware (HW) and/or firmware (FW) to perform its calculations and decisions.

The BW scaling factor to be used for the SoC 101 is dynamically selected by the BW scaling module 200. But in accordance with other embodiments, the logic for the BW scaling module 200 may be part of the bus/interconnect circuitry 110 that is associated with the subsystem 102₁-102_{N}. Wherever this logic for the BW scaling module 200 is located, the dynamically scaled factor is used by the bus/interconnect control circuitry 110 to adjust the clock frequency of the bus/interconnect 103 to achieve the scale of BW for the bus/interconnect 103 accordingly.

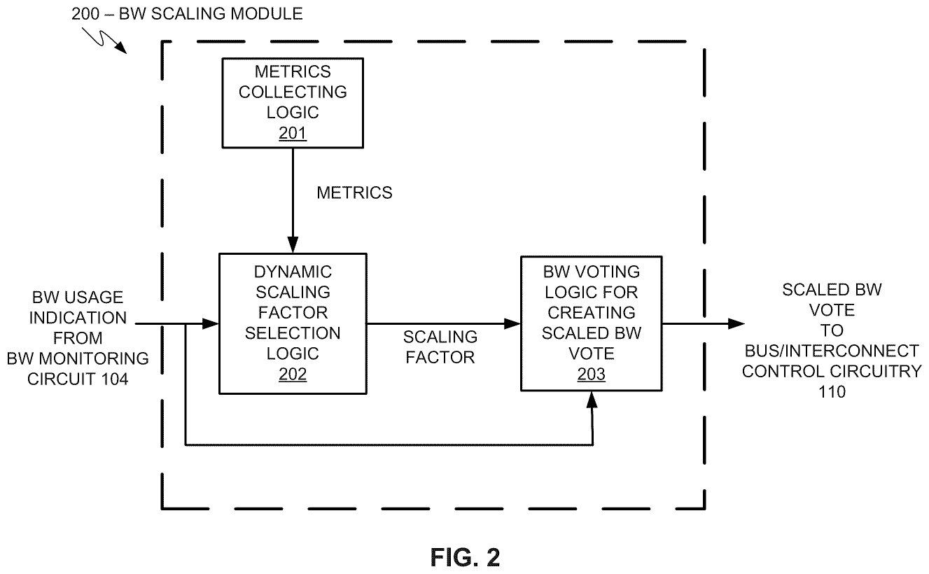

Referring now to FIG. 2, this figure is a block diagram of the BW scaling module 200 of FIG. 1 that is used to dynamically adjust or select the BW scaling factor based on (1) an indication of the BW measured by the BW monitoring circuits 104₁-104_{M} and on (2) one or more metrics related to the subsystems 102₁-102_{N} with which (1) is associated in accordance with an exemplary embodiment. The scaling factor is usually dynamically selected during runtime, by the BW scaling module 200, such as by selecting a 1-times (1×) or 2-times (2×) scaling factor based on (1) and (2).

The inventive principles and concepts of the present disclosure may be implemented in a number of ways. The BW scaling module 200 of FIG. 2 is one example of the manner in which the inventive principles and concepts may be implemented. The BW scaling module 200 may be implemented at different locations within the SoC 101.

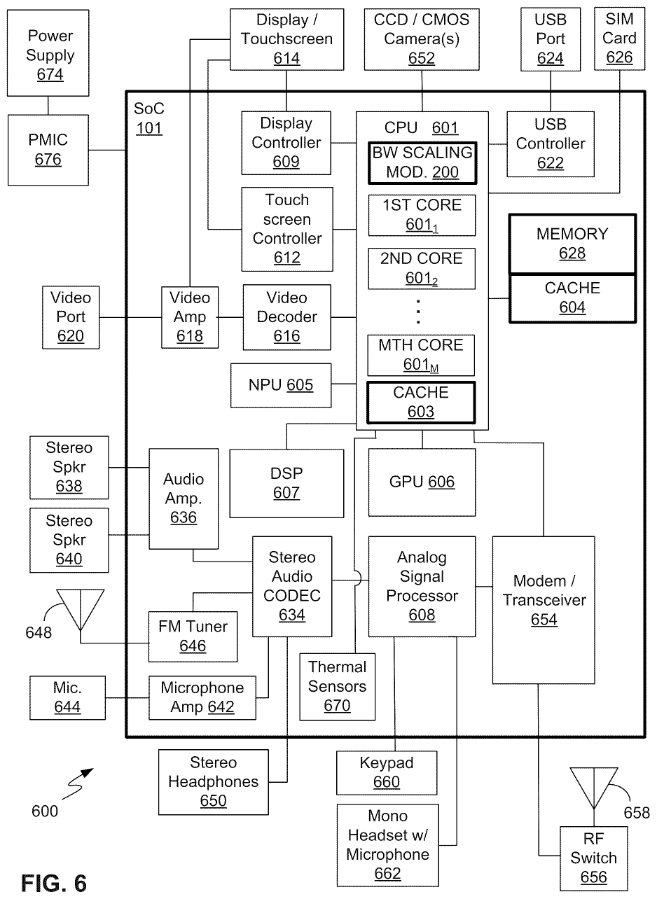

For exemplary purposes, it will be assumed that the BW scaling module 200 of FIG. 2 is implemented inside of each subsystem 102₁-102_{N}, although it is not necessary that each and every subsystem of the SoC 101 implement the system and method of the present disclosure. For purposes of discussion, it will be assumed that the inventive principles and concepts are implemented in subsystem 102₁ of FIG. 1. And according to one exemplary embodiment, as described previously, subsystem 102₁ of FIG. 1 may comprise a multi-core CPU 601 (see FIG. 6) of the SoC 101.

The metrics collecting logic 201 of the BW scaling module 200 of FIG. 2 monitors and collects metrics of the subsystem 102₁. The inventive principles and concepts are not limited with respect to the particular metrics that are monitored and collected, but they will typically include at least one of (1) the operating frequency of the subsystem 102₁ and (2) information relating to events associated with accessing memory (e.g., cache accesses, refills, prefetches, misses), which have an effect on the latency boundness of the measured traffic.

More specifically, all of these metrics may be collected by logic 201 of FIG. 2 via periodic sampling of the CPU counters or cache counters. This sampling can be done in software (SW) (sampling on order of milliseconds) by a subsystem 102 or by a remote hardware/firmware (HW/FW) entity (sampling on order or microseconds). Metrics of a subsystem 102₁ may be characterized as the following lettered elements (A)-(C). Each lettered metric will be described and how each may influence the BW scaling factor:

### Metric (A)—CPU/Core/Subsystem Counters

(A-i). Current CPU Operating Frequency: Higher value (sampled periodically or interrupt driven when operating frequency changes) implies system is more busy (higher perf state/requirements). This means higher count would influence the BW scaling factor to be higher.
(A-ii). Cycle Count or Instruction Count: Higher counts (per constant sampling time) implies system is more busy (higher perf state/requirements). This means higher count would influence the BW scaling factor to be higher.
(A-iii). Memory Stall Cycle Count: Higher counts (either per constant sampling time or as a percentage/ratio of sampled cycle count) implies system is more stalled on memory. This means higher values would influence the BW scaling factor to be higher.

### Metric (B)—Cache Counters

(B-i) Cache Misses: Higher counts (either per constant sampling time or as a percentage/ratio of cache accesses, cache refills, or cache prefetches) implies system is more stalled on memory. This means higher values would influence the BW scaling factor to be higher.
(B-ii) Cache Accesses (or Prefetches or Refills): Higher counts (either per constant sampling time or as an inverse ratio to misses as mentioned in A) implies system is more dependent on memory. This means higher values would influence the BW scaling factor to be higher.

### Metric (C)—Combination of Counters from A and/or B

(C-i) Example Ratio of Cache Misses to Instructions: Higher Misses per Instructions implies workload is more memory bound. This means higher values would influence the BW scaling factor to be higher.

It is noted that these metrics do NOT share the same importance (and hence weightage) in deciding the scaling factor. For example, likely the cache access or cache prefetch counters are not that useful since they are mostly similar to the raw BW data already collected. Meanwhile, CPU frequency, cache miss or memory stall related metrics provide more relevant/valuable feedback to classify the relationship between the subsystem and memory to more effectively determine an appropriate scaling factor.

Referring back to FIG. 2, the dynamic scaling factor selection logic 202 of FIG. 2 receives metric information from the metrics collecting logic 201 and the indication of BW usage from the BW monitoring circuit 104₁ and processes this input to select a scaling factor. This scaling factor is output from the dynamic scaling factor selection logic 202 and sent to the input of the BW voting logic 203.

The dynamic scaling factor selection logic 202 can be configured to either adjust a default scaling factor (i.e., to scale the default scaling factor by some scalar) or to select a scaling factor. For example, in the former case, a 2× scaling factor can be multiplied by a scalar equal to 0.5 to produce a 1× scaling factor whereas in the latter case a scaling factor of 1× can be selected.

The dynamic scaling factor selection logic 202 usually does not have to take traffic measured over the communication bus 103 into account and/or BW usage of the communication bus 103 into account. The dynamic scaling factor selection logic 202 may also select the scaling factor solely based on the metrics provided by the metrics collecting logic 201.

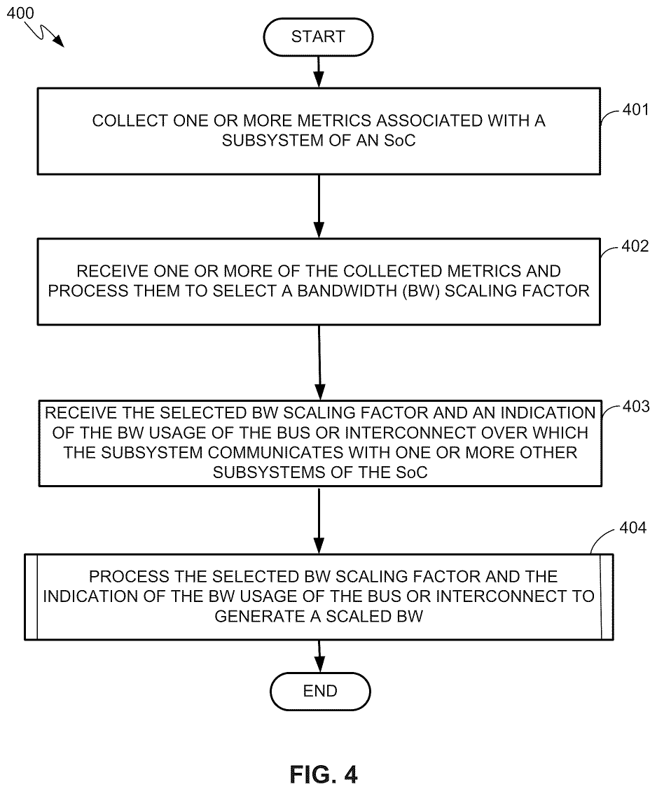

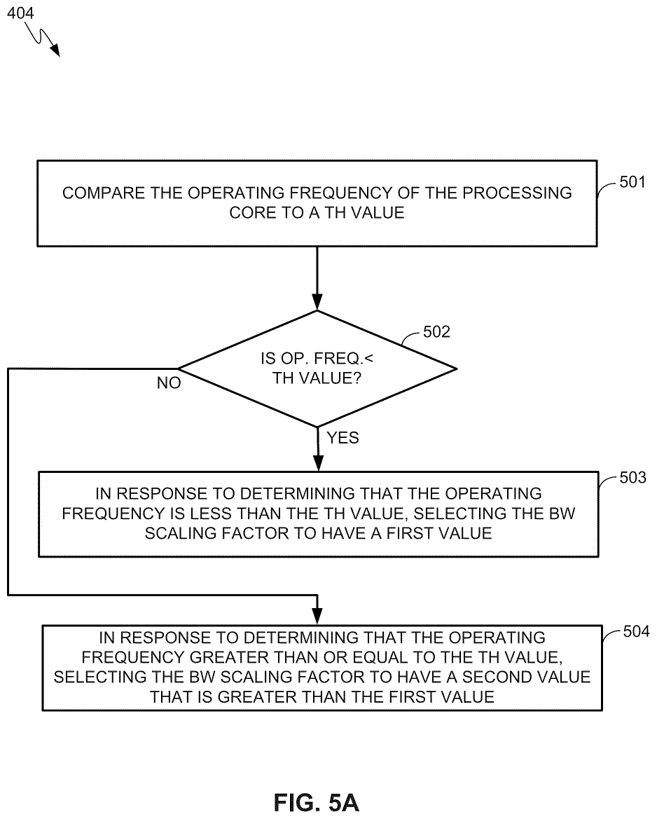

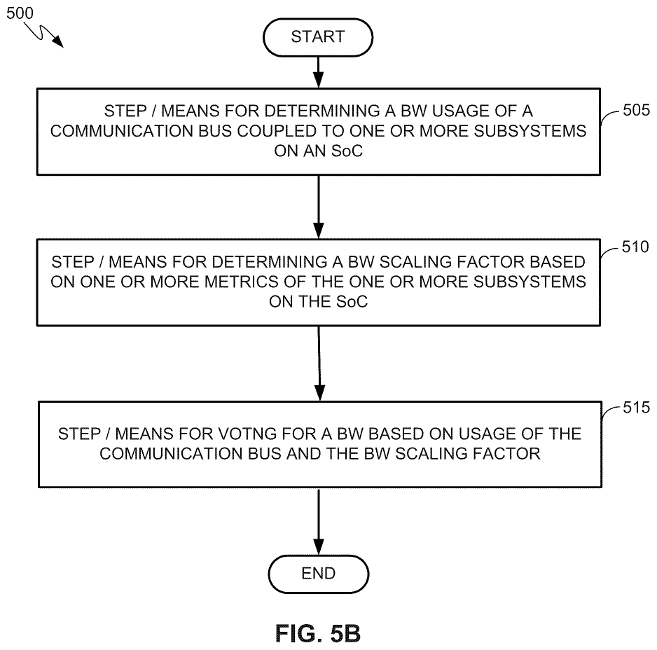

The scaling factor from the dynamic scaling factor selection logic, and the present BW usage of the communication bus 103 are then input into the BW voting logic 203. The BW voting logic multiplies the BW usage by a selected scaling factor to obtain a scaled BW. The scaling factor selected by the BW voting logic to multiply against the BW usage is described in more detail in connection with routing/block 404 of FIGS. 4-5. The scaled BW is output from the BW voting logic 203 and sent to the bus/interconnect control circuitry 110 as a scaled BW vote.

For example, a 2× scaling factor (i.e. 2× BW usage) may be selected by the BW voting logic 203 when metrics indicate that the CPU 601 (see FIG. 6) is perceived to be in a “high performance” state (i.e. high CPU operating frequency). Meanwhile, a 1× scaling factor (i.e. 1× BW usage) may be selected by BW voting logic 203 when the CPU 601 is in a more “high efficiency” state (e.g., low CPU operating frequency/low clock rate). This evaluation of the CPU 601 by the BW voting logic 203 is described in FIG. 5A.

The scaled BW vote that is outputted/generated by the BW voting logic 203 (and which is the final output of the overall BW scaling module 200 sent to the bus/interconnect control circuitry 110) may be used to adjust (e.g. inflate) the value used to determine the clock frequency of the bus 103.

As one benefit of the scaled BW vote, having a dynamic scaling factor allows the system 100 to be more flexible/adaptive to the true needs of the system 100 for use cases of a PCD 600 (see FIG. 6) where communication traffic on the bus 103 may be the same. This means that the system 100 can run more efficiently across various use cases of the PCD 600 (i.e. more optimal balance of performance and power/battery life).

As one specific example, a use case A for a PCD 600 may produce X GB/s bandwidth and run at Y GHz clock rate while a use case B for a PCD 600 may produce 0.5*X GB/s bandwidth but run at 2*Y GHz clock rate. In a conventional bus 103, use case B would usually result in a vote for a bus/interconnect rate that is half of use case A.

However, the system 100 having its scaled BW vote (output of FIG. 2 & FIG. 4) would take other metrics like core/cpu clock rates into account so that use case B could have a vote to the bus/interconnect 103 that is more than half of use case A (i.e. it is scaled up by the appropriate scaling factor).

With the scaled BW vote received from the BW scaling module 200, the bus/interconnect control circuitry 110 of FIG. 1 then adjusts the clock of the bus/interconnect 103 accordingly to achieve the BW voted for by BW scaling module. Since in most cases the BW of the bus/interconnect 103 is shared among multiple subsystems, the bus/interconnect control circuitry 110 may take into account BW votes from other subsystems 102 that use the same bus/interconnect resources in determining how BW is to be allocated among the subsystems 102.

The bus/interconnect control circuitry 110 may aggregate the votes/requests from the various subsystems 102 to determine the final vote for the bandwidth needed for the bus/interconnect 103. Therefore, the scaled BW voted for by the subsystem 102₁ may not be precisely the BW that is allocated to the subsystem 102₁.

By utilizing these metrics from each of the subsystems 102, significant power savings can be achieved while having no or less negative impact on user-experience sometimes caused by an under-voted bus/clock voting in conventional communication bus architectures.

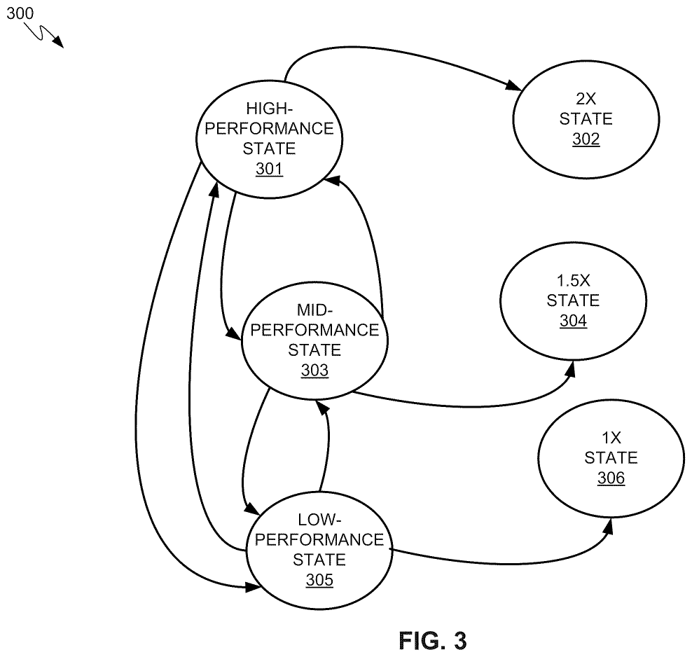

As indicated above, the inventive principles and concepts can be implemented in a number of ways. FIG. 3 illustrates a state diagram 300 representing operations of a state machine that can be used to implement the inventive principles and concepts in accordance with an exemplary embodiment in which the state machine switches scaling factor states based at least in part on metrics that indicate whether the subsystem is in a high-performance, mid-performance or low-performance state.

In accordance with this exemplary embodiment, when the subsystem 102₁-102_{N} is in a high-performance state 301, the state machine places the subsystem 102₁-102_{N} in a 2× state 302 in which a 2× BW scaling factor is used. When the subsystem 102₁-102_{N} is in a mid-performance state 303, the state machine places the subsystem 102₁-102_{N} in a 1.5× state 304 in which a 1.5× BW scaling factor is used.

When the subsystem 102₁-102_{N} is in a low-performance state 305, the state machine places the subsystem 102₁-102_{N} in a 1× state 306 in which a 1× BW scaling factor is used. The 1×, 1.5× and 2× scaling factors are only examples of the scaling factors that could be used for this purpose.

According to one exemplary embodiment, a determination that a CPU core is in a high, mid, or low performance state is based on the core's clock rate itself (i.e. operating frequency of the subsystem 102) which is one of the metrics described above. Usually running a CPU core at a higher clock rate yields higher performance. The algorithm/logic that determines the operating frequency of each subsystem 102 will choose the clock rate based on the performance needs of the subsystem 102.

According to another exemplary embodiment, periodically checking some of the cpu/cache event metrics could help determine the performance state of each subsystem 102. For example, a relatively high number of clock cycles, instructions, or cache events (as described above) could imply higher performance needs of a particular subsystem 102 which would benefit from a higher BW scaling factor. Higher cycles or instructions burned per second generally imply a subsystem 102 is more busy (and similarly, for a high number of cache events as well).

FIG. 4 illustrates a flow diagram representing a method 400 of the present disclosure in accordance with one exemplary embodiment. FIG. 4 and its method 400 track the exemplary embodiment of FIG. 2 when the BW scaling module 200 may be divided into the three logical blocks 201, 202, & 203 as depicted in FIG. 2. It is noted that the BW scaling module 200 may also be created/executed using different logical blocks 505, 510, & 515 as illustrated in FIG. 5B described below.

Referring now to FIG. 4, block 401 of FIG. 4 represents the step of, in metrics collecting logic, collecting one or more metrics associated with a first subsystem of the SoC 101. Block 402 represents the step of, in the dynamic scaling factor selection logic, receiving one or more of the collected metrics from the metric collecting logic and processing the one or more of the collected metrics to select a BW scaling factor.

Block 403 represents the step of, in the BW voting logic, receiving the selected BW scaling factor and an indication of the BW usage of a bus 103 or interconnect 103 over which subsystems of the SoC communicate. Block 404 represents the step/subroutine of, in the BW voting logic, processing the selected BW scaling factor and the indication of BW usage to generate a scaled BW. Further details of routine/block 404 will be described below in connection with FIG. 5A.

Referring now to FIG. 5A, this figure illustrates a flow diagram representing the processing step/subroutine 404 in accordance with an exemplary embodiment in which the BW voting logic 404 uses an operating frequency of a core of a multi-core CPU to help determine a scaled BW vote that is sent to the bus/interconnect control circuitry 110. Blocks 501 and 502 of FIG. 5A represent the steps of comparing the operating frequency of the processing core (i.e. CPU 601—see FIG. 6) to a first threshold (TH) value to determine whether the operating frequency of the processing core is less than the TH value or is greater than or equal to the TH value. The TH value could be an operating frequency usually denoted in hertz (Hz) (i.e. 9.0 GHz, 8.0 GHz, 7.0 GHz, etc. etc.).

Block 503 represents the step of, in response to determining that the operating frequency of the processing core is less than the TH value, selecting the BW scaling factor to have a first value. This first value could be the BW scaling factor which was generated by the dynamic scaling factor selection logic 202.

Block 504 represents the step of, in response to determining that the operating frequency of the processing core is greater than or equal to the TH value, selecting the BW scaling factor to have a second value, the second value being greater than the first value.

This second value from block 504 is usually greater than the BW scaling factor which was generated by the dynamic scaling selection logic 202. The BW voting logic in block 504 may multiply the BW scaling factor generated by the dynamic scaling selection logic 202 by an integer value (i.e. such as 2, 3, 4, or 5). Any integer value could be used without departing from the scope of this disclosure.

Subsequently, at the end of block 503 or at the end of block 504, the selected BW scaling factor determined by the BW voting logic (based on the comparison block 502) is multiplied against the bus usage provided by the dynamic scaling factor selection logic 202. The resultant value of this multiplication is the scaled BW vote that is sent from the BW voting logic 203 to the bus/interconnect circuitry 110.

Referring now to FIG. 5B, this figure illustrates a flow diagram representing a method 500 of the present disclosure in accordance with an alternative exemplary embodiment compared to flow diagram of FIG. 4 and logic divisions of FIG. 2. FIG. 5B illustrates how the logic and functions of the BW scaling module 200 may be created/grouped and explained and/or summarized differently compared to the exemplary embodiments illustrated in FIGS. 2 and 4.

FIG. 4 and its method 400 track the exemplary embodiment of FIG. 2 when the BW scaling module 200 may be provided with three logical blocks 201, 202, & 203 as shown in FIG. 2. Meanwhile, the BW scaling module 200 and its core functions may be included in three logical blocks 505, 510, & 515 as illustrated in FIG. 5B described below. As explained above, the BW scaling module 200 may comprise at least one of: hardware, software, firmware, or a combination thereof. Further, the BW scaling module 200 may be present in one or a plurality of elements within an SoC 101.

That is, the present disclosure is not limited to a BW scaling module 200 present in a single defined element within an SoC 101. This means that the BW scaling module 200 could have portions (i.e. logic) present within different and several elements within an SoC 101. The BW scaling module 200 may have two or more elements that are a combination of hardware, software, and/or firmware as understood by one of ordinary skill in the art.

Referring now to FIG. 5B, block 505 represents the step of the BW scaling module 200 determining a BW usage of the communication bus 103 coupled to the one or more subsystems 102 on the SoC 101. Block 505 also represents a means for determining the BW usage of the communication bus 103. Block 505 tracks the logic described in connection with the BW monitoring circuits 104 illustrated in FIG. 1.

Next, block 510 represents the step of the BW scaling module 200 determining a BW scaling factor based on metrics of one or more subsystems 102 on the SoC 101. Block 510 also represents a means for determining a BW scaling factor based on one or more metrics of the one or more subsystems 102 on the SoC 101. Block 510 may track the logic described above in connection with logic 202 of FIG. 2 or it may track routine 404 illustrated in FIG. 5A.

According to one exemplary embodiment, block 510 may track blocks 501-504 described above where the BW scaling module 200 compares the operating frequency of a processing core 601 (see FIG. 6) of at least one subsystem 102 to a threshold (TH) value. And then the BW scaling module 202 sets the BW scaling factor to either to a first value (Block 503) or a second value (Block 504) based on the comparison in Block 502.

And lastly, block 515 represents the step of the BW scaling module 200 determining voting for a BW based on the usage of the communication bus 103 and the BW scaling factor determined in Block 510. Block 515 also represents a means for voting for a BW based on the usage of the communication bus 103 and the BW scaling factor determined in Block 510.

Block 515 tracks the output of block 200 of FIG. 2 where the BW scaling module 200 multiplies the BW scaling factor by the BW usage to created a scaled BW vote. This scaled BW vote is transmitted to bus/interconnect control circuitry 110 illustrated in FIG. 1. The bus control circuitry 110 ultimately decides the BW for bus 103 based on one or more BW votes received from each of the plurality of subsystems 102 as shown in FIG. 1.

Referring now to FIG. 6, this figure illustrates an example of a portable computing device (PCD) 600 that may be, for example, a laptop or palmtop computer, a cellular telephone or smartphone, a personal digital assistant (PDA), a navigation device, a smartbook; a portable game console including an Extended Reality (XR) device, a Virtual Reality (VR) device, an Augmented Reality (AR) device, or a Mixed Reality (MR) device; a satellite telephone, an automotive device, an Internet-of-Things (IoT) device, etc. The PCD 600 may include exemplary embodiments of systems, methods, computer-readable media, and other examples of the inventive principles and concepts of the present disclosure.

The PCD 600 may comprise an SoC 101, which comprises the system 100 shown in FIG. 1 or a similar system comprising the logic 200 shown in FIG. 2 or similar logic. For purposes of clarity, some interconnects, signals, etc., are not shown in FIG. 6.

The SoC 101 may include a CPU 601, an NPU 605, a GPU 606, a DSP 607, an analog signal processor 608, a modem/transceiver 654, or other processors. The CPU 601 may include one or more CPU cores, such as a first CPU core 601₁, a second CPU core 601₂, etc., through an M^{th} CPU core 601_{M}. The CPU 601 may also include cache memory, such as level 1(L1 ) and level 2(L2 ) cache memory 603. For illustrative purposes, it is assumed herein that the CPU 601 comprises the BW scaling module 200, also shown in FIG. 2, but BW scaling module 200 may be external (not shown) to the CPU 601 as described above in detail.

A display controller 609 and a touch-screen controller 612 may be coupled to the CPU 601. A touchscreen display 614 external to the SoC 101 may be coupled to the display controller 609 and the touch-screen controller 612. The PCD 600 may further include a video decoder 616 coupled to the CPU 601. A video amplifier 618 may be coupled to the video decoder 616 and the touchscreen display 614. A video port 620 may be coupled to the video amplifier 618. A universal serial bus (“USB”) controller 622 may also be coupled to CPU 601, and a USB port 624 may be coupled to the USB controller 622. A subscriber identity module (“SIM”) card 626 may also be coupled to the CPU 601.

One or more memories 628, such as main memory, may be coupled to the CPU 601. The one or more memories 628 may include both volatile and non-volatile memories. Examples of volatile memories include static random access memory (“SRAM”) and dynamic random access memory (“DRAM”). The one or more memories 628 may include local cache memory and/or a system-level cache memory 604 (e.g., level 3(L3 ) cache memory.

A stereo audio CODEC 634 may be coupled to the analog signal processor 608. An audio amplifier 636 may be coupled to the stereo audio CODEC 634. First and second stereo speakers 638 and 640, respectively, may be coupled to the audio amplifier 636. A microphone amplifier 642 may be coupled to the stereo audio CODEC 634, and a microphone 644 may be coupled to the microphone amplifier 642. A frequency modulation (“FM”) radio tuner 646 may be coupled to the stereo audio CODEC 634. An FM antenna 648 may be coupled to the FM radio tuner 646. Further, stereo headphones 650 may be coupled to the stereo audio CODEC 634. Other devices that may be coupled to the CPU 601 include one or more digital (e.g., CCD or CMOS) cameras 652.

The modem or RF transceiver 654 may be coupled to the analog signal processor 608 and to the CPU 601. An RF switch 656 may be coupled to the RF transceiver 654 and to an RF antenna 658. In addition, a keypad 660 and a mono headset with a microphone 662 may be coupled to the analog signal processor 608. The SoC 101 may have one or more internal or on-chip thermal sensors 670. A power supply 674 and a power management IC (PMIC) 676 may supply power to the SoC 101.

Firmware or software may be stored in any of the above-described memories, or may be stored in a local memory directly accessible by the processor hardware on which the software or firmware executes. Execution of such firmware or software comprising the BW scaling module 200 by the CPU 601 may control aspects of any of the above-described methods or configure aspects of any of the above-described systems.

Any such memory or other non-transitory storage medium having firmware or software stored therein in computer-readable form for execution by processor hardware may be an example of a “computer-readable medium,” as the term is understood in the patent lexicon.

Implementation examples are described in the following numbered clauses:
1. A bandwidth (BW) voting logic coupled to one or more subsystems, the BW voting logic comprising:
   a module configured to:
   determine a BW usage of a communication bus coupled to the one or more subsystems;
   determine a BW scaling factor based on one or more metrics of the one or more subsystems; and
   vote for a BW based on BW usage of the communication bus and the BW scaling factor.
2. The bandwidth voting logic of clause 1, wherein the one or more metrics comprise at least one of: an operating frequency, a cycle count or instruction count, a memory stall cycle count, a cache miss, a cache access, a cache prefetch, a cache refill; a ratio of two or more of these values; or any combination of these values.
3. The bandwidth voting logic of clause 2, wherein the operating frequency is an operating frequency of a central processing unit (CPU).
4. The bandwidth voting logic of clauses 2-3, wherein the BW scaling factor is set at a first value when the operating frequency has a first magnitude; the BW scaling factor is set at a second value when the operating frequency has a second magnitude, the second value being greater than the first value, and the second magnitude being greater than the first magnitude.
5. The bandwidth voting logic of clause 3, wherein the CPU comprises a multicore CPU.
6. The bandwidth voting logic of clauses 1-5, wherein the module comprises at least one of: hardware, software, firmware, or a combination thereof.
7. The bandwidth voting logic of clauses 1-6, where the module determines BW usage with a bandwidth monitoring circuit coupled to the one or more of the subsystems.
8. The bandwidth voting logic of clauses 1-7, wherein the module multiplies the BW scaling factor by BW usage to create a scaled BW vote.
9. The bandwidth voting logic of clause 8, wherein the module transmits the scaled BW vote to bus control circuitry.
10. A method for providing a bandwidth (BW) vote to bus control circuitry, the method comprising:
   determining a BW usage of a communication bus coupled to one or more subsystems;
   determining a BW scaling factor based on one or more metrics of the one or more subsystems; and
   providing a vote for BW based on BW usage of the communication bus and the BW scaling factor.
11. The method of clause 10, wherein the one or more metrics comprise at least one of: an operating frequency, a cycle count or instruction count, a memory stall cycle count, a cache miss, a cache access, a cache prefetch, a cache refill; a ratio of two or more of these values; or any combination of these values.
12. The method of clause 11, wherein the operating frequency is an operating frequency of a central processing unit (CPU).
13. The method of clauses 10-12, wherein the BW scaling factor is set at a first value when the operating frequency has a first magnitude; the BW scaling factor is set at a second value when the operating frequency has a second magnitude, the second value being greater than the first value, and the second magnitude being greater than the first magnitude.
14. The method of clause 12, wherein the CPU comprises a multicore CPU.
15. The method of clauses 10-14, wherein determining the BW usage of a communication bus coupled to one or more subsystems comprises determining the BW usage with a bandwidth monitoring circuit coupled to the one or more of the subsystems.
16. The method of clauses 10-15, further comprising multiplying the BW scaling factor by BW usage to create a scaled BW vote.
17. The method of clause 16, further comprising transmitting the scaled BW vote to bus control circuitry.
18. A computer program product comprising a non-transitory computer usable medium having a computer readable program code embodied therein, said computer readable program code adapted to be executed to implement a method for providing a bandwidth (BW) vote to bus control circuitry, said method comprising:
   determining a BW usage of a communication bus coupled to one or more subsystems;
   determining a BW scaling factor based on one or more metrics of the one or more subsystems; and
   providing a vote for BW based on BW usage of the communication bus and the BW scaling factor.
19. The computer program product of claim 18, wherein the one or more metrics comprise at least one of: an operating frequency, a cycle count or instruction count, a memory stall cycle count, a cache miss, a cache access, a cache prefetch, a cache refill; a ratio of two or more of these values; or any combination of these values.
20. The computer program product of clause 19, wherein the operating frequency is an operating frequency of a central processing unit (CPU).

Alternative embodiments will become apparent to one of ordinary skill in the art to which the invention pertains in view of the present disclosure. Therefore, although selected aspects have been illustrated and described in detail, it will be understood that various substitutions and alterations may be made therein.

What is claimed is:

1. A bandwidth (BW) voting logic coupled to one or more subsystems, the BW voting logic comprising:
a module configured to:
determine a BW usage of a communication bus coupled to the one or more subsystems;
determine a BW scaling factor based on one or more metrics of the one or more subsystems; and
vote for a BW based on BW usage of the communication bus and the BW scaling factor.

2. The bandwidth voting logic of claim 1, wherein the one or more metrics comprise at least one of: an operating frequency, a cycle count or instruction count, a memory stall cycle count, a cache miss, a cache access, a cache prefetch, a cache refill; a ratio of two or more of these values; or any combination of these values.

3. The bandwidth voting logic of claim 2, wherein the operating frequency is an operating frequency of a central processing unit (CPU).

4. The bandwidth voting logic of claim 3, wherein the BW scaling factor is set at a first value when the operating frequency has a first magnitude; the BW scaling factor is set at a second value when the operating frequency has a second magnitude, the second value being greater than the first value, and the second magnitude being greater than the first magnitude.

5. The bandwidth voting logic of claim 2, wherein the CPU comprises a multicore CPU.

6. The bandwidth voting logic of claim 1, wherein the module comprises at least one of: hardware, software, firmware, or a combination thereof.

7. The bandwidth voting logic of claim 1, where the module determines BW usage with a bandwidth monitoring circuit coupled to the one or more of the subsystems.

8. The bandwidth voting logic of claim 1, wherein the module multiplies the BW scaling factor by BW usage to create a scaled BW vote.

9. The bandwidth voting logic of claim 8, wherein the module transmits the scaled BW vote to bus control circuitry.

10. A method for providing a bandwidth (BW) vote to bus control circuitry, the method comprising:
determining a BW usage of a communication bus coupled to one or more subsystems;
determining a BW scaling factor based on one or more metrics of the one or more subsystems; and
providing a vote for BW based on BW usage of the communication bus and the BW scaling factor.

11. The method of claim 10, wherein the one or more metrics comprise at least one of: an operating frequency, a cycle count or instruction count, a memory stall cycle count, a cache miss, a cache access, a cache prefetch, a cache refill; a ratio of two or more of these values; or any combination of these values.

12. The method of claim 11, wherein the operating frequency is an operating frequency of a central processing unit (CPU).

13. The method of claim 12, wherein the BW scaling factor is set at a first value when the operating frequency has a first magnitude; the BW scaling factor is set at a second value when the operating frequency has a second magnitude, the second value being greater than the first value, and the second magnitude being greater than the first magnitude.

14. The method of claim 12, wherein the CPU comprises a multicore CPU.

15. The method of claim 10, wherein determining the BW usage of a communication bus coupled to one or more subsystems comprises determining the BW usage with a bandwidth monitoring circuit coupled to the one or more of the subsystems.

16. The method of claim 10, further comprising multiplying the BW scaling factor by BW usage to create a scaled BW vote.

17. The method of claim 16, further comprising transmitting the scaled BW vote to bus control circuitry.

18. A computer program product comprising a non-transitory computer usable medium having a computer readable program code embodied therein, said computer readable program code adapted to be executed to implement a method for providing a bandwidth (BW) vote to bus control circuitry, said method comprising:
determining a BW usage of a communication bus coupled to one or more subsystems;
determining a BW scaling factor based on one or more metrics of the one or more subsystems; and
providing a vote for BW based on BW usage of the communication bus and the BW scaling factor.

19. The computer program product of claim 18, wherein the one or more metrics comprise at least one of: an operating frequency, a cycle count or instruction count, a memory stall cycle count, a cache miss, a cache access, a cache prefetch, a cache refill; a ratio of two or more of these values; or any combination of these values.

20. The computer program product of claim 19, wherein the operating frequency is an operating frequency of a central processing unit (CPU).
